(19) United States
(12) Patent Application Publication
(10) Pub. No.: US 2023/0023031 A1
(43) Pub. Date: Jan. 26, 2023

(54) System and Method of Using QR Codes for Accessing Life Details of a Deceased Person

(71) Applicant: Coryna Muckenfuss, Hurt, VA (US)

(72) Inventor: Coryna Muckenfuss, Hurt, VA (US)

(21) Appl. No.: 17/873,693

(22) Filed: Jul. 26, 2022

Related U.S. Application Data
(60) Provisional application No. 63/225,719, filed on Jul. 26, 2021.

(51) Int. Cl. G06F 16/955; G06K 7/14

(52) U.S. Cl. CPC G06F 16/9566; G06K 7/1417

(57) ABSTRACT

The present invention relates to a system and method for scanning and storing an obituary, social media accounts, pictures, videos, and other forms of media about a deceased person. The system stores the information in a database and provides a QR code that can be engraved or mounted onto a headstone, urn, or memorial device. The QR code includes an encoded URL of a website that is configured to display the stored information of the deceased person. The QR code is scannable using an imaging device and redirects to the website. The system enables authenticated users to update and edit information. The system helps memorialize loved ones and prevents their life history from being forgotten by future generations. The system can also be used with deceased pets' headstones/gravestones/markers.

### CROSS-REFERENCE TO RELATED APPLICATION

The present application claims priority to, and the benefit of, U.S. Provisional Application No. 63/225,719, which was filed on Jul. 26, 2021 and is incorporated herein by reference in its entirety.

### FIELD OF THE INVENTION

The present invention relates generally to the field of scannable codes. More specifically, the present invention relates to a system and method of using a dynamic QR code for scanning and storing an obituary and other related information about the deceased person. The QR code can be engraved right onto the headstone, urn, or memorial device and can be scanned to redirect to a website that details the life of the deceased persons as well as their genealogy, social media accounts, photos, videos, and more. The information can also be updated by authenticated users. Accordingly, the present disclosure makes specific reference thereto. Nonetheless, it is to be appreciated that aspects of the present invention are also equally applicable to other like applications, devices, and methods of manufacture.

### BACKGROUND

By way of background, when an individual passes away, their loved ones may decide to inter or entomb the body of the deceased at a site within a cemetery. In some instances, the deceased may be placed within a plot of land signified by a physical headstone demarcating the deceased's burial location. In other instances, funeral urns are used which are used for collecting ashes. Loved ones, friends, and family of a deceased person want to remember details of the life of the deceased person and even pass-through said details to future generations. Standard gravestones and memorial sites are ineffective at sharing information about deceased friends and family. As a result, details, anecdotes, and more are not remembered after many years have elapsed and are lost for future generations.

Individuals generally document details of one's life in an obituary and try to digitally store video locally in their computers. However, such storage of media is not reliable and cannot be accessed by all. Further, it is impossible for individuals to collect all the information about a deceased and store same centrally so that anyone can access the information. Individuals desire a method to ensure that they can share details of the life of their loved ones from generations to generations.

Generally, when individuals go to gravestones, they remember the deceased person but are unable view, listen, or interact with the details of the life of the deceased. Individuals desire a method to view, preserve, and interact with details of the life of their loved ones after they pass away.

Therefore, there exists a long felt need in the art for a system and method that securely stores information relating to a deceased person. There is also a long felt need in the art for a system and method that enables easy access of stored information of a deceased person. Additionally, there is a long felt need in the art for a system and method that enables the deceased person's information to be passed and accessed across generations. Moreover, there is a long felt need in the art for a system and method that enables individuals to view, listen, and interact with videos, images and more of their loved ones who have passed away. Further, there is a long felt need in the art for a system and method that displays a name, a birth date, a death date, obituary, genealogy, social media accounts, voice recordings, and much more of a deceased person. Furthermore, there is a long felt need in the art for a system that memorializes loved ones and prevents them from being forgotten by future generations. Finally, there is a long felt need in the art for a system and method that prevents friends and family (i.e., approved) members from being forgotten after they have passed away.

The subject matter disclosed and claimed herein, in one embodiment thereof, comprises a method of accessing obituary and other information of a deceased person using a scannable Quick Response (QR) code. The method is implemented using a server and further comprising the steps of scanning the QR code using a portable electronic device; automatically redirecting to a URL encoded in the QR code; displaying a website, wherein the website includes obituary information, social media websites, pictures, videos, and other forms of media of the deceased person; the QR code is placed on a headstone, memorial site, or urn of the deceased person; and the said plurality of content displayed on the website is configured to be updated by an authenticated user.

In this manner, the novel method and associated system of accessing obituaries and other information of the present invention accomplish all of the forgoing objectives and provides a user a scannable QR code that can be placed on a headstone, memorial site, urn, and other similar items and enables information to be accessed from a database when the code is scanned. The system securely stores obituary information, social media websites, pictures, videos, and other forms of media, enabling individuals to view different types of information about a person of interest, an ancestor, or loved one.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method of accessing obituary and other information of a deceased person using a scannable Quick response (QR) code. The method further comprising the steps of scanning the QR code using a portable electronic device; automatically redirecting to a URL encoded in the QR code; displaying a website, wherein the website includes obituary information, social media websites, pictures, videos, and other forms of media of the deceased person; the QR code is placed on a headstone, memorial site, or urn of the deceased person; and the said plurality of content displayed on the website is configured to be updated by an authenticated user.

In yet another embodiment, a method for storing and scanning an obituary and other related information about a deceased person is described. The method includes the steps of storing said obituary and other related information about the deceased person in a database; generating a dynamic QR code; encoding the dynamic QR code with a URL; generating a website for displaying said obituary and other related information about the deceased person, wherein the URL is the address of the website; adhering the dynamic QR code on a headstone, memorial site, or urn of the deceased person; scanning the dynamic QR code using a portable electronic device; and redirecting to the URL for displaying the obituary and other related information.

In yet another embodiment, a scannable dynamic QR code for accessing details of the life of a deceased person is disclosed. The QR code is a 2D dynamic code and includes an encoded URL of a website wherein the website displays details of the life of the deceased person, wherein the QR on being scanned by a portable electronic device redirect to the website for pulling the details from a database for display.

In yet another embodiment, a system for providing details of the life of a deceased person is disclosed. The system includes a website server including at least one processor wherein the server is configured to receive, from an electronic device, a dynamic QR generation request; generate a dynamic QR code encoded with a URL of a website; receive, from the electronic device, details of the life of the deceased person; storing, in a database, details of the life of the deceased person; receive, from the electronic device, the URL of the website wherein the URL corresponds to the details of the deceased person; and displaying, on the electronic device, details of the life of the deceased person.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of a system for storing and accessing information of a deceased person in accordance with the disclosed architecture;

FIG. 2 illustrates a perspective view showing a gravestone equipped with a dynamic QR code prepared in accordance with the disclosed architecture;

FIG. 3 illustrates an exemplary user interface displayed to a user upon scanning the dynamic QR code of the present invention in accordance with the disclosed architecture;

FIG. 4 illustrates another user interface displayed by the website enabling a user such as a family member of the deceased to update/edit deceased information stored in databases of the system and displayed upon scanning the dynamic QR code in accordance with the disclosed architecture;

FIG. 5 illustrates a flow diagram depicting a process of generating dynamic QR code and website for a deceased person in accordance with the disclosed architecture;

FIG. 6 illustrates a flow diagram depicting a process of using the dynamic QR code for accessing a deceased individual's information on the website in accordance with the disclosed architecture;

FIG. 7 illustrates a flow diagram depicting a process of editing and updating a deceased individual's personal information on the website by a user in accordance with the disclosed architecture;

FIG. 8 illustrates a perspective view showing the QR code being scanned to redirect to the deceased person's information website in accordance with the disclosed architecture; and

FIG. 9 illustrates a perspective view of an urn with an attached QR code in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a system and method that securely stores information relating to a deceased person. There is also a long felt need in the art for a system and method that enables easy access of stored information of a deceased person. Additionally, there is a long felt need in the art for a system and method that enables the deceased person's information to be passed and accessed across generations. Moreover, there is a long felt need in the art for a system and method that enables individuals to view, listen, and interact with videos, images and more of their loved ones who have passed away. Further, there is a long felt need in the art for a system and method that displays a name, a birth date, a death date, obituary, genealogy, social media accounts, voice recordings, and much more of a deceased person. Furthermore, there is a long felt need in the art for a system that memorializes loved ones and prevents them from being forgotten by future generations. Finally, there is a long felt need in the art for a system and method that prevents friends and family (i.e., approved) members from being forgotten after they have passed away.

The present invention, in one exemplary embodiment, is a novel system for providing details of the life of a deceased person. The system includes a website server including at least one processor wherein the server is configured to receive, from an electronic device, a dynamic QR generation request; generate a dynamic QR code encoded with a URL of a website; receive, from the electronic device, details of the life of the deceased person; storing, in a database, details of the life of the deceased person; receive, from the electronic device, the URL of the website wherein the URL corresponds to the details of the life of the deceased person; and displaying, on the electronic device, details of the life of the deceased person.

The subject matter described herein for facilitating scan-triggered services may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a non-transitory computer readable medium having stored thereon computer executable instructions that when executed by the processor of a computer perform steps. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

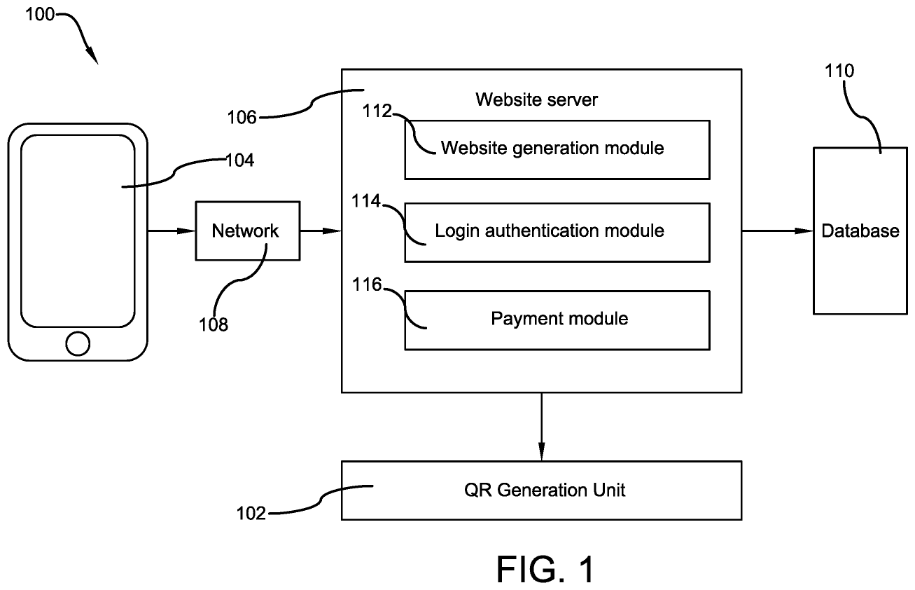

Referring initially to the drawings, FIG. 1 illustrates a schematic view of one potential embodiment of a system for storing and accessing information of a deceased person in accordance with the disclosed architecture. The deceased person information system 100 of the present invention is designed for storing obituary and other related information about a deceased person. More specifically, the system 100 uses a dynamic Quick Response (QR) code generated by a QR generation unit 102 based on a request of a user using a computing device 104. The QR generation unit 102 is coupled to a website server 106 which is accessible to the computing device 104 via a wireless network 108. The QR code is configured to be scannable by an imaging device (such as a camera of a smartphone) for connecting users such as family (i.e., approved) members to a website hosted by the website server 106 wherein the website provides the information or database about life of a deceased person as described later in the disclosure.

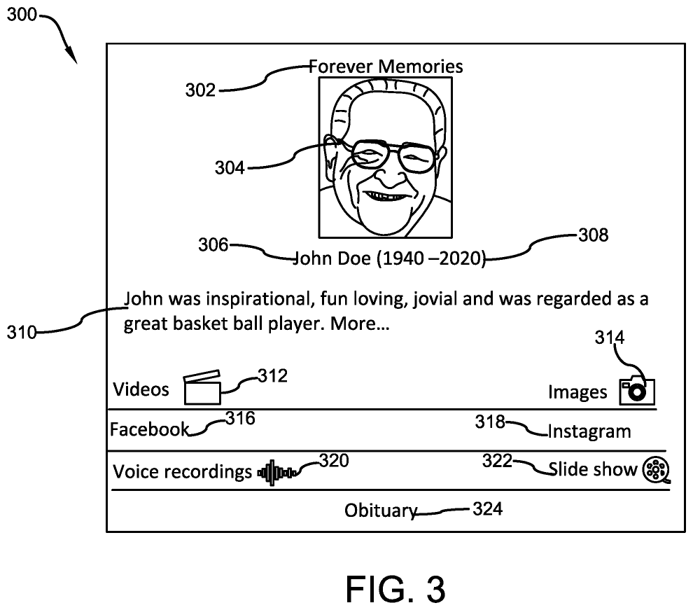

The website server 106 is configured for storing information of a deceased person in one or more databases 110 which can be a central database, cloud database, or distributed database. The database 110 may have a plurality of entries comprising deceased person information and the information may include pictures, videos, and other forms of media in various formats. The website server 106 has a website generation module 112 which is configured to generate and provide a customized website for displaying information about a deceased person as illustrated in FIG. 3. The website generation module 112 provides a template of web pages that are used for displaying a website wherein the website is displayed when a corresponding QR code having a redirected URL of the website has been encoded therein.

An advantage of the system 100 is that it enables one or more family (i.e., approved) members of a deceased person to update and edit the information displayed by the website and stored in the database 110. For updating information, a user is required to login to the website server and the server 106 provides a login authentication module 114 for authenticating a user before updating the information of a deceased person. The services and offerings of the system 100 can be used by individuals, memorial sites, and more on a subscription basis which can include maintenance of website, QR codes, and more and accordingly, the server 106 provides a payment module 116 for processing of payments by customers. The cost may include an initial cost and a periodic subscription fee.

It should be noted that once a user orders a QR code using the system, a dynamic QR code is laser printed and is provided to the user for embedding or removably attaching to a headstone, memorial site, urn, and other similar items. Along with the dynamic QR code, administration credentials are provided as well to the customer that helps in updating the information on a website whose short redirection URL is encoded in the QR code.

The term “database” should be understood be to a collection of data stored on a computer readable medium in a manner such that the data can be retrieved by a computer. The term “database” can also be used to refer to the computer readable medium itself (e.g., a physical object which stores the data).

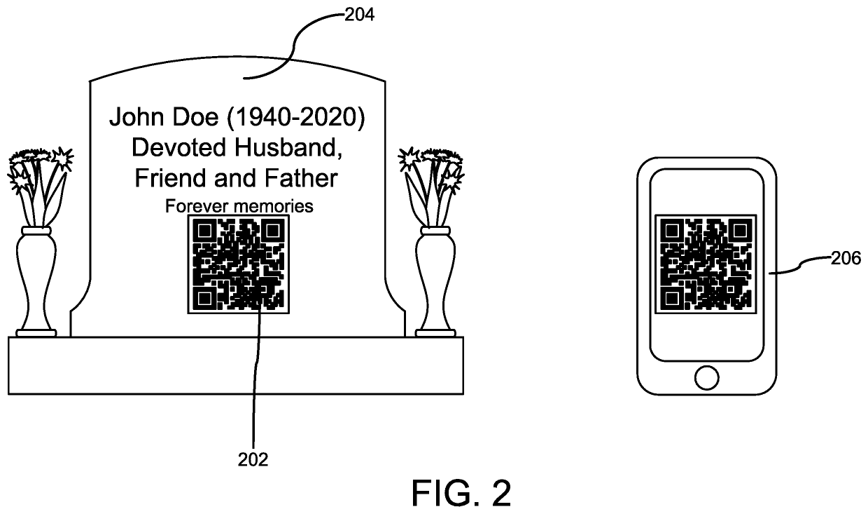

FIG. 2 illustrates a perspective view showing a gravestone equipped with a dynamic QR code prepared in accordance with the disclosed architecture. The dynamic QR code 202 used in the present invention is scannable by a smartphone 206 (can be same as 104 of FIG. 1) and can be placed on a headstone, memorial site, urn, and other similar items. The QR code 202 is a 2D barcode that stores alphanumeric information just like a barcode and specifically, includes a redirection URL to a website. Further, content of the website can be changed without modifying the QR code 202 and the QR code 202 enables information to be pulled or accessed from the database 110 when the QR code 202 is scanned wherein the information is related to an individual buried at a grave or memorial site 204 upon which the QR code 202 is attached as illustrated in the present embodiment.

In some embodiments, the QR code 202 can be a micro QR code, a standard barcode, or any other suitable machine-readable code. The QR code 202 uniquely identifies a deceased of the gravestone 204 and a user may simply direct a user's smartphone 104 to automatically access a website or other online resource that has the information regarding the deceased. The QR code 202 can be integrated into the gravestone 204 or can also be removably attached.

FIG. 3 illustrates an exemplary user interface displayed to a user upon scanning the dynamic QR code of the present invention in accordance with the disclosed architecture. As described earlier, the QR code is configured to redirect users to a website containing information about a deceased for which the QR code is prepared. As illustrated, the website 300 displays a logo or any other indicia 302 such as “Forever Memories” which can be used for identifying or branding of the system of the present invention. The website 300 displays an image 304 of the deceased wherein the displayed image 304 can be updated by a user having the administration panel of the website 300 as described later in the disclosure. Name 306 and life span 308 of the deceased are also displayed on the website 300.

A biography 310 of the deceased is displayed which may include a life summary, milestones, family details, and more. A video icon 312 configured to include a plurality of videos is displayed and can be clicked to view one or more videos of the deceased. An images icon 314 configured to include a plurality of images is displayed and can be clicked for viewing by users. The website 300 may be linked to a plurality of social media accounts like Facebook, Instagram, Twitter, and more of the deceased person. Each social media account can be accessed using a corresponding link, such as, a Facebook icon 316 or Instagram icon 318 as exemplary shown on the website 300. It should be noted that any number of social media accounts can be coupled or compiled with the website 300 and further in some embodiments, public images and videos from the coupled or compiled social media accounts can be included in the images and videos of the website 300. Voice recordings icon 320 includes the voice memos, notes, and other audio of the deceased. They may include voice messages of other individuals about the deceased as well. Machine language generated slideshows are shown by the website upon clicking the Slideshow icon 322. Obituary information 324 is also displayed by the website and can be accessed anytime as per preferences of the users.

It should be noted that for storing images, videos, voice recordings and more, a user may buy/subscribe additional storage space on the server enabling memories of the deceased person to be stored securely. Further, the website 300 is scaled as per the size of the display a computing device and is securely rendered. The website 300 provides an embedded video player and audio player for playing videos and audio respectively.

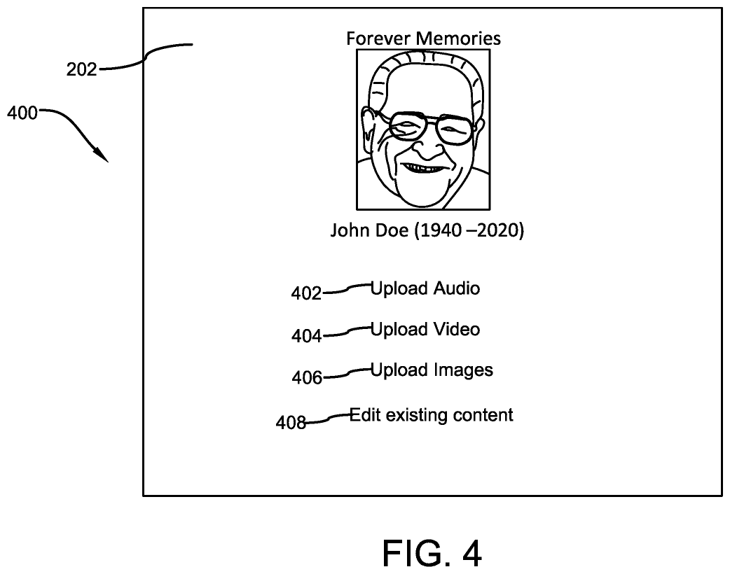

FIG. 4 illustrates another user interface displayed by the website enabling a user such as a family member of the deceased to update/edit deceased information stored in databases of the system and displayed upon scanning the dynamic QR code in accordance with the disclosed architecture. The families of the deceased individual would be given a username and password and have lifetime access to add and edit the content on the page 300 using the interface 400. It should be noted that the user interface 400 is accessible only when a user is authenticated by the login authentication module 114 of the server. As illustrated, the user interface 400 displays details of the deceased individual shown in FIG. 3.

Additionally, the interface 400 includes an “Upload Audio” icon 402 for uploading audio related to the deceased. An “Upload Video” icon 404 is used for uploading videos related to the deceased. An “Upload Images” icon 406 is used for uploading images related to the deceased. In cases, where the authenticated user wants to edit existing content on the web site 300, then “Edit existing content” icon 408 is used. Accordingly, the information can be deleted, updated, and modified.

The uploads and changes made to the content are reviewed by the system for obscenity and more and after approval, the changes are reflected on the website and can be viewed by users upon scanning the corresponding dynamic QR code.

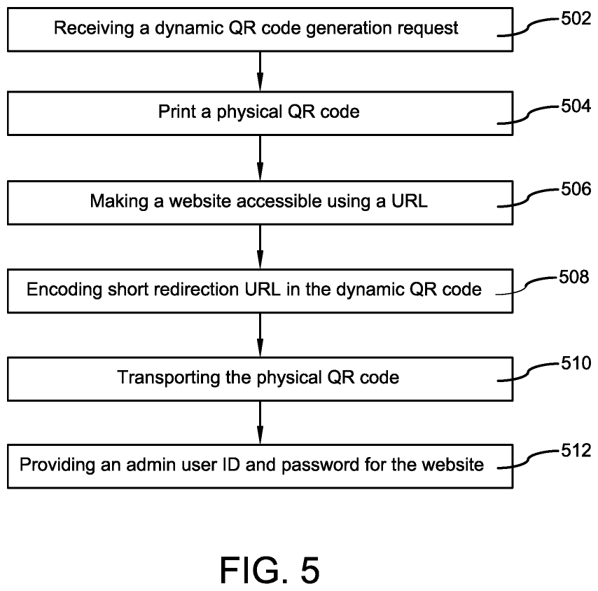

FIG. 5 illustrates a flow diagram depicting a process of generating dynamic QR code and website for a deceased person in accordance with the disclosed architecture. Initially, the system receives a dynamic QR code generation request from a user. QR code can be requested for a deceased person or can alternatively be requested for a living person (Step 502). Once payment is successful, a unique physical QR code is laser printed and generated (Step 504). Thereafter, a website is developed automatically having a URL which can be used for accessing the website (Step 506). The website is configured to contain information about a person which can be deceased or alive.

The printed QR code is encoded with short redirection URL that will allow a user to scan the QR code to access the website (Step 508). Then, the encoded physical QR code is transported to the user who requested the code generation (Step 510). It should be appreciated that the QR code can also be delivered in digital form via an email to the user (Step 512). Finally, the admin user ID and password for accessing the web site to update content of the website are provided (Step 514).

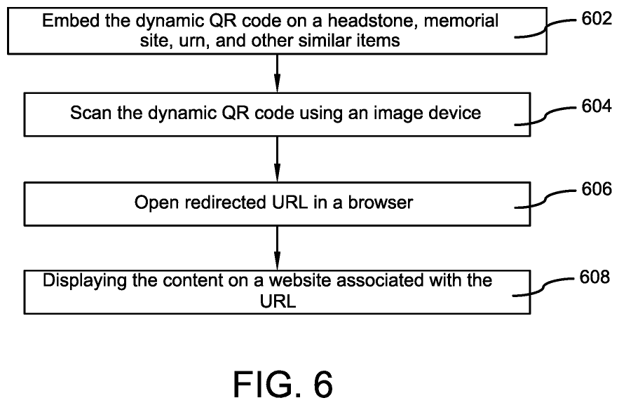

FIG. 6 illustrates a flow diagram depicting a process of using the dynamic QR code for accessing deceased individual information on the website in accordance with the disclosed architecture. Initially, the dynamic QR code is embedded or attached on a headstone, memorial site, urn, and other similar items (Step 602). The QR code is scratch resistant and can be attached to any type of surface. Once, the QR code is attached, it can be scanned using any scanning application or device by a user wishing to know more about a deceased person (Step 604). Once scanned, the encoded URL is opened in a browser application in the electronic/computing device using the QR code scanned (Step 606). Finally, the content is displayed on the website associated with the URL (Step 608) wherein the content is updated and uploaded by a user as described in FIG. 5.

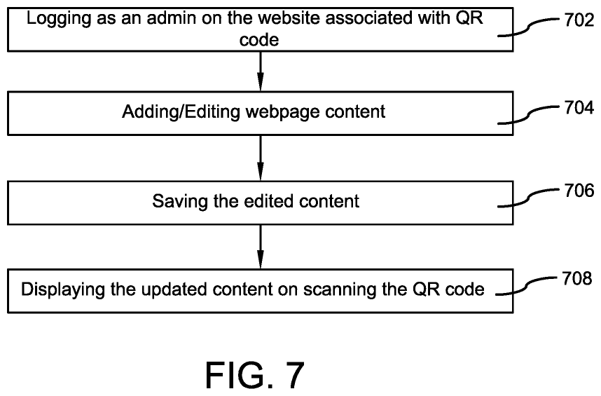

FIG. 7 illustrates a flow diagram depicting a process of editing and updating deceased individual information on the website by a user in accordance with the disclosed architecture. Initially, a user is logged on the website associated with a deceased person using user name and password provided at the time of purchasing the QR code or subscribing the website service (Step 702). Once logged in, the webpages are updated and edited as described in FIG. 4 (Step 704). The edited contents are saved and stored in database (Step 706). Finally, when the associated QR code is scanned, the updated information is displayed on the website (Step 708).

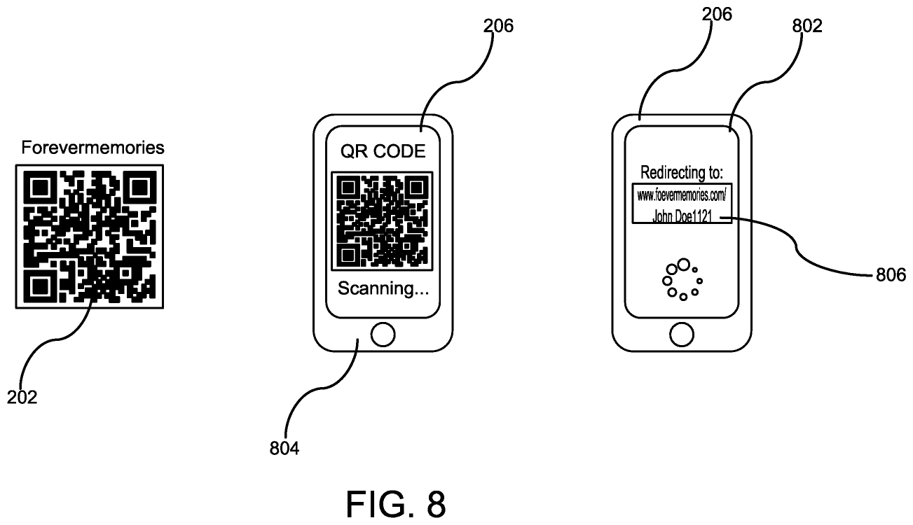

FIG. 8 illustrates a perspective view showing the QR code being scanned to redirect to a deceased person's information website in accordance with the disclosed architecture. The QR code 202 can be a dynamic 2D code that can be used even when the URL of the associated website is updated. Initially, the QR code 202 is scanned using imaging device 802 such as camera of the computing device 206 and the QR code is visible on the display screen 804 of the device 206. Then, the associated website having a URL 806, such as, www.forevermemories can be opened in a browser application enabling the users to access information displayed on the website.

It should be appreciated that the website may include obituary information, social media websites, pictures, videos, and other forms of media, enabling individuals to view different types of information about an ancestor or loved one and prevents friends and family (i.e., approved) members from being forgotten, along with their life history, after they have passed away.

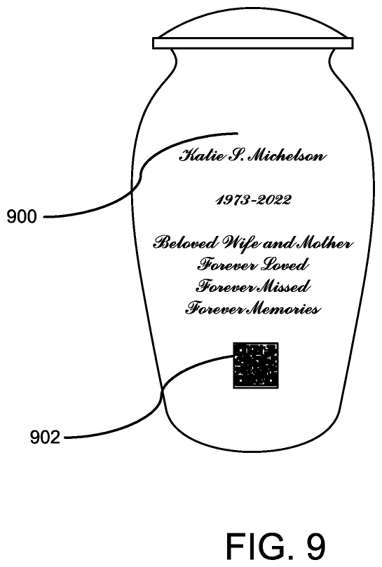

FIG. 9 illustrates a perspective view of an urn with an attached QR code in accordance with the disclosed architecture. In the present embodiment, an urn 900 has an attached QR code 902 which is configured to be scanned for redirecting to a website containing information of a deceased person with whom the urn 900 is related. When the QR code 902 is scanned, relevant information is pulled from the database of the system and information is displayed.

It should be appreciated that the system helps memorialize loved ones and prevent them from being forgotten by future generations. The system can be used for deceased pets' headstones/gravestones/markers.

Of course, some of the teachings set forth herein are susceptible to being implemented in forms other than computer readable media. For example, based on the teachings of this disclosure, one of ordinary skill in the art could implement a system including a database, a server computer and one or more user computers in which the user computers could be used to provide any or all of the above noted processes while relying on processing done by the server and information stored in the database. Various other methods, machines, and articles of manufacture could also be implemented based on this disclosure by those of ordinary skill in the art without undue experimentation and should not be excluded from protection by claims included in this or any related document.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “QR code”, “dynamic QR code”, “Quick Response code”, and “deceased person QR code” are interchangeable and refer to the dynamic QR code 202, 904 of the present invention. Similarly, as used herein “deceased person information system”, “forever memories system”, and “system” are interchangeable and refer to the deceased person information and display system 100 of the present invention.

Notwithstanding the forgoing, the dynamic QR code 202, 904 and the deceased person information and display system 100 of the present invention can be of any suitable size and configuration as is known in the art without affecting the overall concept of the invention, provided that it accomplishes the above stated objectives. One of ordinary skill in the art will appreciate that the dynamic QR code 202, 904 and the deceased person information and display system 100 as shown in the FIGS. are for illustrative purposes only, and that many other sizes and shapes of the dynamic QR code 202, 904 and the deceased person information and display system 100 well within the scope of the present disclosure. Although the dimensions of the dynamic QR code 202, 904 and the deceased person information and display system 100 are important design parameters for user convenience, the dynamic QR code 202, 904 and the deceased person information and display system 100 be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A deceased person information system comprising:
a database for storing information related to a deceased person;
a Quick Response (QR) code generated by a QR generation unit;
a website server for maintaining and accessing said database;
wherein said QR generation unit coupled to said website server;
a computing device having an imaging device for scanning said QR code and connecting a user to a website of said website server; and
further wherein said website having said database of said stored information of said deceased person.

2. The deceased person information system of claim 1, wherein said imaging device having a camera for scanning said QR code.

3. The deceased person information system of claim 2 further comprising a wireless network for connecting said computing device with said website server.

4. The deceased person information system of claim 3, wherein said stored information is selected from a group consisting of an obituary, a social media compilation, an audio recording, a video recording, an image, a photo, a picture, a life summary, and a life history.

5. The deceased person information system of claim 4, wherein said website server is selected from a group consisting of a central database, a cloud database, and a distributed database.

6. The deceased person information system of claim 5, wherein said website server having a website generation module configured to generate and provide a customized website for displaying said stored information about the deceased person.

7. The deceased person information system of claim 6, wherein said website server includes a redirected URL for directing said scanned QR code to said stored information.

8. The deceased person information system of claim 1 further comprising a login authentication module for logging in an approved member to said website server for updating and editing said stored information.

9. The deceased person information system of claim 8 further comprising a subscription service for accessing said website server.

10. The deceased person information system of claim 9, wherein said subscription service for accessing said login authentication module.

11. The deceased person information system of claim 10, wherein said subscription service having a payment module for processing payments of the user.

12. The deceased person information system of claim 11, wherein said subscription service having an initial cost and a periodic fee.

13. The deceased person information system of claim 1, wherein said QR code mounted to a headstone, a gravestone, a memorial site, or an urn.

14. The deceased person information system of claim 4, wherein said social media compilation having a link to a social media account.

15. The deceased person information system of claim 4, wherein said audio recording includes voice recordings of the deceased person.

16. A deceased person information system comprising:
a database for storing information related to a deceased person;
a Quick Response (QR) code generated by a QR generation unit;
a website server for maintaining and accessing said database;
wherein said QR generation unit coupled to said website server;
a computing device having an imaging device for scanning said QR code and connecting a user to a website of said website server;
wherein said website having said database of said stored information of said deceased person;
wherein said stored information is selected from a group consisting of an obituary, a social media compilation, an audio recording, a video recording, an image, a photo, a picture, a life summary, and a life history;
wherein said audio recording includes voice recordings of the deceased person; and
further wherein said QR code mounted to a headstone, a gravestone, a memorial site, or an urn.

17. The deceased person information system of claim 16, wherein said imaging device having a camera for scanning said QR code.

18. The deceased person information system of claim 17 further comprising a wireless network for connecting said computing device with said website server.

19. A deceased information system comprising:
a database for storing information related to a deceased;
a Quick Response (QR) code generated by a QR generation unit;
a website server for maintaining and accessing said database;
wherein said QR generation unit coupled to said website server;
a computing device having an imaging device for scanning said QR code and connecting a user to a website of said website server;
wherein said website having said database of said stored information of said deceased;
wherein said stored information is selected from a group consisting of an obituary, a social media compilation, an audio recording, a video recording, an image, a photo, a picture, a life summary, and a life history; and
further comprising a wireless network for connecting said computing device with said web site server.

20. The deceased information system of claim 19, wherein said deceased is a pet.
